(19) United States
(12) Patent Application Publication
(10) Pub. No.: US 2004/0129159 A1
(43) Pub. Date: Jul. 8, 2004

(54) Plate material for printing and printing machine

(76) Inventors: Yasuharu Suda, Hiroshima-ken (JP); Toyoshi Ohto, Hiroshima-ken (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/476,482

(22) PCT Filed: Jan. 30, 2003
(86) PCT No.: PCT/JP03/00891

(30) Foreign Application Priority Data
Feb. 5, 2002 (JP) 2002-028700

(51) Int. Cl. B41N 1/14

(52) U.S. Cl. 101/456; 101/467

(57) ABSTRACT

A printing plate has a photosensitive layer (3) including a photocatalyst formed on a strip-shaped windable substrate (1) with or without another layer (2) interposed so that the printing plate is wound into a roll shape. An unused portion is extracted from the printing plate roll (8A) each time of replacement of a printing plate and an image can be formed on the unused portion whereupon printing plate replacement is realized without regenerating of the printing plate.

### TECHNICAL FIELD

The present invention relates to a printing plate and a printing press including the printing plate.

### BACKGROUND OF THE INVENTION

In recent years, digitalization of printing processes has been progressing in the art. This technology involves creation of images and manuscripts in digitized form on a personal computer or reading images on a scanner and directly makes a printing plate ready for printing based on the digital data thus obtained. This makes it possible to save labor in the printing processes and also to conduct high-definition printing with ease.

So-called PS plates (presensitized plates) have been commonly used as printing plates to date. A PS plate includes a hydrophilic non-image area made of anodized aluminum and has one or more hydrophobic image areas formed by curing a photosensitive resin on the surface of the anodized aluminum. Making a printing plate ready for printing with such a PS plate requires a number of steps and hence, is time-consuming and costly. It is therefore difficult to reduce the time and the cost required for a printing process. Especially in short-run printing, the requirement for such plural steps causes increased printing costs. Additionally, since use of a PS plate requires a development step using a developer, serious problems arise not only with the need for considerable amounts of labor but also with environmental pollution caused by treatment of developer waste.

Further, it is a common practice to expose a PS plate the surface of which is in contact with a film through which a desired image is perforated, to light. This causes problems in making the printing plate ready for printing directly from digital data and in promoting a digitized printing process. Moreover, after completion of printing of a pattern, it is necessary to replace the printing plate with another one in order to conduct printing of the following pattern, and used printing plates are thrown away.

To solve the above-described problems of PS plates, methods have been proposed to meet the digitization of a printing process while making it possible to omit the development step, and some of such methods have come into commercial use. For example, Japanese Patent Application Laid-Open (KOKAI) Publication No. SHO 63-102936 discloses a process of making a plate ready for printing which comprises the steps of: applying ink containing a photosensitive resin used as an ink for a liquid ink-jet printer, onto the surface of a printing plate; and curing an image area by irradiation with light. Japanese Patent Application Laid-Open (KOKAI) Publication No. HEI 11-254633, on the other hand, discloses a process for making a color offset printing plate ready for printing by an ink-jet head through which solid ink is jetted. However, an ink-jet system takes a long time to write a high-resolution image, and conversely, high-speed image writing with an ink-jet system cannot ensure satisfactory print quality.

Also included in known methods are a process for making a printing plate ready for printing, which comprises the step of writing, with a laser beam (IR), an image on a printing plate, which is made of a PET (polyethylene terephthalate) film on which a laser absorbing layer such as carbon black covered with a silicone resin layer is formed, to cause the laser absorbing layer to evolve heat, which ablates off the silicone resin layer; and another process for preparing a printing plate, which comprises the step of coating a lipophilic laser absorbing layer on an aluminum plate, coating a hydrophilic layer on the laser absorbing layer, and then ablating off the hydrophilic layer with a laser beam as in the above-described process. Since these methods can write an image on a printing plate directly from digital data and require no development process, these methods are applied to some integrated printing presses each of which has an image forming unit for making a print plate ready for printing. However, as the result of these methods, printing plate dust generated by ablation causes defects in making the printing plate ready for printing and contamination of the printing press, such as an image forming unit, thereby requiring much maintenance labor.

For example, Japanese Patent Application

Laid-Open (KOKAI) Publication No. HEI 10-250027 refers to a latent image block copy making use of a titanium dioxide photocatalyst, a fabrication process of the latent image block, and a printing press on which the latent image block is made. Japanese Patent Application Laid-Open (KOKAI) Publication No. HEI 11-147360 also discloses an offset printing process by a printing plate making use of a photocatalyst. Each of these disclosures writes an image using light (practically, ultraviolet light) capable of activating a photocatalyst and regenerating a printing plate by hydrophobization of the photocatalyst caused by heat treatment. Further, Japanese Patent Application Laid-Open (KOKAI) Publication No. HEI 11-105234 discloses a process for making a printing plate, which comprises the step of hydrophilizing a photocatalyst with activating light, i.e., ultraviolet light, and then writing an image area by heat-mode recording.

As disclosed in the paper (pages 124-125) entitled “Study of Photo-Induced Hydrophilic Conversion on the TiO₂ Surface Involved by Structural Conformation”, (by Minabe et al.) distributed at the Fifth Symposium on “Recent Developments of Photocatalytic Reactions” of the Photo Functionalized Materials Society in 1998, Prof. Fujishima, Prof. Hashimoto, et al. of the Research Center for Advanced Science and Technology, The University of Tokyo, have confirmed that a titanium dioxide photocatalyst is hydrophilized by heat treatment. According to the description in the above paper, the processes disclosed in the laid-open patent applications referred to in the above, that is, the processes each of which hydrophobizes a photocatalyst by heat treatment to regenerate a printing plate cannot regenerate to reuse a printing plate or make a printing plate.

Considering the above circumstances, the Inventors have developed a printing plate, on which an image can be written directly from digital data without generating plate dust and which can attain practically-satisfactory print result, and have applied patent applications for the printing plates (Japanese Patent Application numbers HEI 10-229109 and HEI 10-229110).

Successively, the Inventors have been enthusiastically researching to develop a printing plate more suitable for an integrated printing press on which a printing plate is made ready for printing; specifically, develop a structure of a printing plate able to be replaced with an unused printing plate faster than regenerating a printing plate as replacement of a printing plate.

Namely, the present invention aims at providing a printing plate that can be replaced more quickly than regenerating a printing plate as replacement of a printing plate.

Further, the present invention also aims at providing an integrated printing press that enables a printing plate to be replaced rapidly.

### DISCLOSURE OF THE INVENTION

In order to attain the foregoing aims, there is provided a printing plate having a surface on which an image is able to be formed by irradiating the surface with light, wherein a photosensitive layer including a photocatalyst is formed on a strip-shaped windable substrate with or without another layer interposed. With this structure, the printing plate is previously wind into a roll shape and extracted a unused portion, on which an image is to be formed, from the roll each time of replacement of a printing plate so that it is advantageously possible to rapidly replace a printing plate because the replacement does not take a long time while regenerating of the printing plate to an unused state takes a long time. Additionally, a new printing plate is made ready for printing each time whereupon the substrate can avoid deterioration and highly-reliable making of a printing plate ready for printing can be realized.

The photocatalyst has a property that is converted by irradiation with activating light and a property that decomposes an organic compound on the surface. If the former property is utilized, the photosensitive layer serves as the surface of the printing plate and a conversion of the property of the photocatalyst, i.e., a conversion from hydrophobic to hydrophilic, forms the image. Namely, irradiation of a portion of the surface of the printing plate converts the property of the irradiated portion from hydrophobic to hydrophilic. Thereby, the portion converted to hydrophilic serves as a non-image area to which a fountain solution preferentially adheres but hydrophobic ink does not adhere. The portion that has not been irradiated with the activating light serves as an image area to which the hydrophobic ink preferentially adheres but the fountain solution does not adhere.

On the other hand, if the latter property is utilized, a coating, including an organic compound having a hydrophobic group, is formed on the photosensitive layer; and the image is formed in accordance with exposure of a hydrophilic surface of the photosensitive layer which exposure is caused by decomposition of the organic compound by the photocatalyst. Since the property of the photocatlyst is converted to hydrophilic by irradiating with the activating light, the initial state of the photosensitive layer may be hydrophilic or hydrophobic. The exposed portion of the hydrophilic surface of the photosensitive layer serves as a non-image area to which a fountain solution preferentially adheres but hydrophobic ink does not adhere. The portion of the plate surface that has not been irradiated with the activating light serves as an image area to which the hydrophobic ink preferentially adheres but the fountain solution does not adhere because the organic compound keep covering the portion.

As a preferable feature, the phtocatalyst may respond to light having a wavelength equal to or shorter than those of visible light, or may respond to light having a wavelength of 600 nm or shorter. Since a photocatalyst is activated when being irradiated with light having energy higher than the band-gap energy of the photocatalyst, conventional technique concretely utilizes ultraviolet light (having wavelength of 380 nm or shorter) that is high in energy and short in wavelength. However, ultraviolet light requires handling with care and an emitting unit for ultraviolet light tends to be large in size and expensive. As a solution, the usage of the photocatalyst that responds also to visible light can increase alternative emitting units each serving as an image forming unit and a unit tractable for handling and compact size can be used.

The photocatalyst is a titanium oxide photocatalys or a modified titanium oxide photocatalyst. Here, a modified titanium oxide photocatlayst is formed by doping or containing a metal or non-metal element other than elements originally included in the titanium oxide photocatalyst based on the titanium oxide photocatalyst or by changing the stoichimetric ratio of a titanium dioxide photocatalyst in which the ratio of Ti atoms and O atoms are included in a ratio of 1:2. The modified titanium oxide photocatlayst is obtained by improving a titanium oxide photocatalyst so as to respond to visible light as well as ultraviolet light because of setting a new level in the band gap of the titanium oxide photocatalyst.

The present invention also provides a printing press on which a printing plate is made ready for printing. The printing press comprising a printing plate roll formed by the printing plate wound into a roll shape; a plate cylinder around which the printing plate extracted from the printing plate roll is wrapped; an image forming unit for form an image on the surface of the printing plate wrapped around the plate cylinder by irradiating the surface of the printing plate with activating light; and a printing plate replacing unit for spooling a used portion of the printing plate and concurrently extracting an unused portion of the printing plate from the printing plate roll. With this arrangement in the printing press, making a printing plate ready for printing and replacement of a printing plate can be realized by extracting an unused portion from the printing plate roll and forming image on the extracted portion so that it is possible to replace a printing plate more rapidly than regenerating the printing plate to an unused state.

As a preferable feature, the printing plate replacing unit may be included in the plate cylinder. As a result, rapid replacement of a printing plate can be realized without halting an operation of the printing press.

### BRIEF DESCRIPTION OF THE DRAWINGS

FIG. 1 is a sectional view showing the surface of a printing plate according to a first embodiment of the present invention and concurrently showing a photosensitive layer thereof in a hydrophobic state;

FIG. 2 is a sectional view showing the surface of the printing plate the surface according to the first embodiment of the present invention and concurrently showing a photosensitive layer thereof in a hydrophilic state;

FIG. 3 is a schematic diagram showing procedural steps of image forming on a printing plate ready for printing and replacing a used printing plate with an unused printing plate according to the first embodiment of the present invention;

FIG. 4 is a perspective view showing an example of an image (an image area) written on the surface of the printing plate and a white background (a non-image area);

FIG. 5 is a schematic diagram showing an example of a printing press in which the printing plate according to the first embodiment is installed; and

FIG. 6 is a sectional view showing the surface of a printing plate according to a second embodiment of the present invention and concurrently showing a photosensitive layer thereof in a hydrophobic state.

### BEST MODE FOR CARRYING OUT THE INVENTION

Hereinafter, various embodiments of the present invention will now be described with reference to the accompanying drawings.

(A) First Embodiment:

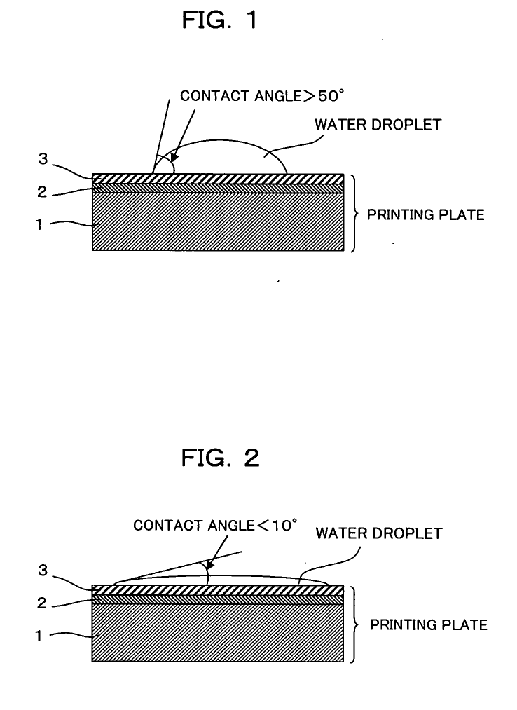

FIG. 1 is a partially sectional view showing a printing plate according to a first embodiment of the present invention. Basically, the printing plate includes substrate 1, an intermediate layer 2 and a photosensitive layer (printing plate surface layer) 3. In this drawing, the substrate 1 is made of a windable flexible material, such as a polymer film or a metal foil made of aluminum or stainless steel. However, the material of the substrate 1 of the present invention should by no means be limited to such a polymer film or a metal foil.

The intermediate layer 2 is formed on the surface of the substrate 1. The intermediate layer 2 is, for example, made of silica (SiO₂), a silicone compound exemplified by silicone resin or silicone rubber, or a metallic oxide semiconductor, such as tungsten oxide WO₃, tin oxide SnO or zinc oxide ZnO. In particular, silicone alkyd, silicone urethane, silicone epoxy, silicone acryl, silicone polyester or the like are used as silicone resin. A metallic oxide semiconductor is preferably used for the substrate 1 made of a polymer film.

The intermediate layer 2 is formed on the substrate 1 to ensure adhesion of the substrate 1 to a later-described photosensitive layer 3 and to improve their firm adhesion. It is possible to ensure adequate adhesive strength between the substrate 1 and the photosensitive layer 3 by interposing an intermediate layer 2 as required. If sufficient adhesive strength is available between substrate 1 and photosensitive layer 3, the intermediate layer 2 can be omitted.

Further, the intermediate layer 2 is sometimes formed in order to enhance the activity of the photosensitive layer 3 including a photocatalyst. The intermediate layer 2 interposed between the substrate 1 and the photosensitive layer 3 as needed enhances the crystallinity of the photosensitive layer 3 and inhibits an electron and a positive hole, which are caused in the photosensitive layer 3 by irradiation with activating light, from recombination so that the activity of the photocatalyst is enhanced. However, an ensured adequate photocatalytic activity of the photosensitive layer 3 can omit the intermediate layer 2 serving an activity enhancer.

If the substrate 1 is in the form of a polymer film, the intermediate layer 2 is formed as a protector of the substrate 1 as required. Additionally, heat treatment is performed in order to form the later-described photosensitive layer 3, the intermediate layer 2 is also effective for preventing impurities included in the substrate 1 from thermodiffusing and from thereby mixing into photocatlyst layer 3, so that a reduction in photocatalytic activity is avoided.

The photosensitive layer 3 including a photocatalyst is formed on the intermediate layer 2 (or the substrate 1). The surface of the photosensitive layer 3 comes to exhibit a high hydrophilicity responsive to irradiation with light having energy higher than the band-gap energy of the photocatalyst. A photocatalyst normally does not show photocatalytic activity unless the photocatalyst is irradiated with light having energy higher than its band-gap energy; since a normal titanium oxide photocatalyst has band-gap energy as high as 3 eV, the photocatalyst is responsive only to ultraviolet light. Ultraviolet light requires handling with care and a device for emitting ultraviolet light is large and expensive. As a solution, the first embodiment utilizes a photocatalyst having an energy level newly set in the band gap, which potocatalyst is thereby responsive also to light having a wavelength longer than those of ultraviolet light, so that not only ultraviolet light but also visible light having a wavelength in the range between 380 nm through 600 nm can be used as the activating light.

Executing a method already known produces a photocatalyst responsive even to visible light. For example, Japanese Patent Laid-Open (KOKAI) Publication No. 2001-207082 discloses a visible-light-responsive photocatalyst obtained by doping nitrogen atoms on the basis of a titanium oxide photocatalyst; Japanese Patent Laid-Open (KOKAI) Publication No. 2001-205104, a visible-light-responsive photocatalyst obtained by doping chromium and nitrogen atoms; and further Japanese Patent Laid-Open (KOKAI) Publication No. HEI 11-197512, a visible-light-responsive photocatalyst obtained by ion implantation using metal ions, such as chromium ions. A visible-light-responsive photocatalyst is produced by another disclosed method utilizing cryogenic plasma. A visible-light-responsive photocatalyst containing platinum is also disclosed. Fabrication of a printing plate according to the present invention can use a visible-light-responsive photocatalyst which has been produced in these known method. Needless to say, the present invention can be realized by using a normal oxide titanium photocatalyst, which is not responsive to visible light.

In order to maintain the above hydrophilic property and to improve the strength of the photocatalyst layer 3 and the adhesion to the substrate 1, the photocatalyst layer 3 may further include the following substance, such as a silica compound exemplified by silica, silica sol, organosilane, or a silicone resin, a metal oxide or a metal hydride exemplified by zirconium, aluminum, titanium, or a fluorine resin.

The crystal structure of a base titanium dioxide photocatalyst is available in rutile, anatase and brucite. These structures are all usable in this embodiment, and they may be used in combination. In consideration of photocatalytic activity, the anatase structure is preferred among these three structures because of the highest photocatalytic activity resulting from its crystal structure. As described below, a titanium oxide photocatalyst is preferably small in particle diameter in order to make photocatalytic activity high. Specifically, the particle diameter of a titanium dioxide photocatalyst is 0.1 μm or smaller, more preferably not greater than 0.05 μm. A preferable photocatalyst is a titanium oxide photocatalyst as described above or a modified product based on a titanium oxide photocatalyst, but should by no means be limited to these examples.

The thickness of the photosensitive layer 3 is preferably in the range of 0.005 to 1 μm because an unduly small thickness makes it difficult to fully utilize the above-described property while an excessively large thickness makes the photosensitive layer 3 susceptible to cracks and causes a reduction in print durability. As this cracking is pronouncedly observed when the thickness exceeds 10 μm, it is necessary to consider this 10 μm as the upper limit even if one tries to enlarge this range of thickness. In practice, this thickness may preferably be set in the range of from 0.03 to 0.5 μm or so.

The photosensitive layer 3 is formed by a selected one of the sol coating processes, the organic titanate process, the sputtering process, the CVD method, the PVD method and other processes. If the sol coating process is adopted, for example, a sol coating formulation employed for use in the sol coating process may contain a solvent, a crosslinking agent, a surfactant and the like in addition to the above-described substances for improving the strength of the titanium oxide photocatalyst and the photosensitive layer 3 and adhesion of the photosensitive layer 3 to the substrate 1. The coating formulation may be either a room temperature drying type or a heat drying type, with the latter being more preferred because, in order to provide the resultant printing plate with improved print durability, it is advantageous to promote the strength of the photosensitive layer 3 by heating. It is also possible to form the photosensitive layer 3 of high strength, for example, by growing an amorphous titanium dioxide layer on a metal substrate by sputtering in a vacuum and then crystallizing the amorphous titanium dioxide by heat treatment or by another method.

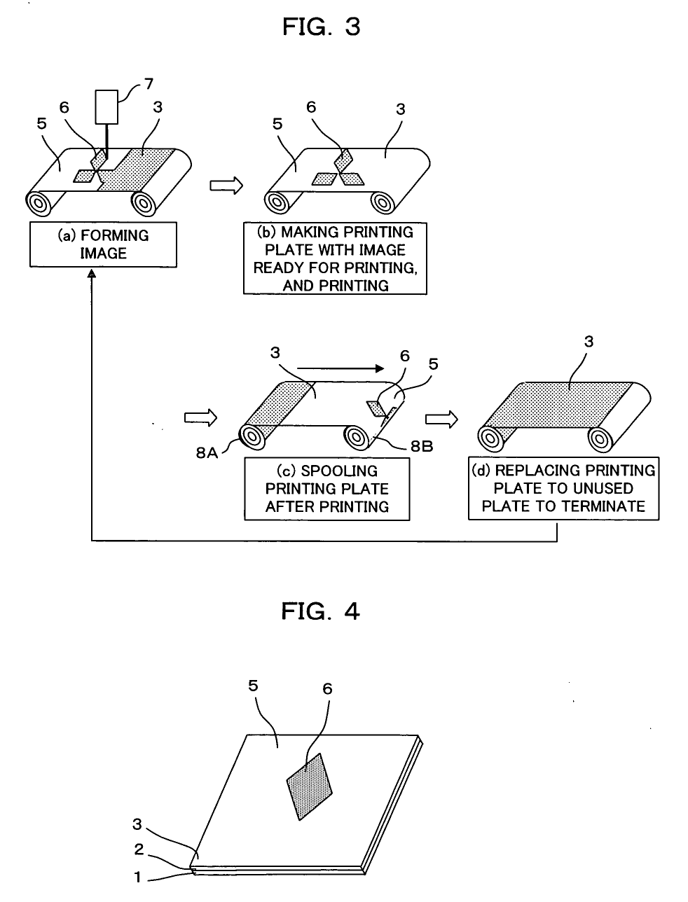

Hereinafter, a description will now be made in relation to a method for making the printing plate according to the present embodiment ready for printing and a method for replacing a used printing plate to an unused printing plate. FIG. 3 is a schematic diagram showing steps, in order of steps (a) to (d), from making a printing plate ready for printing to replacing a used printing plate with an unused one.

As shown in step (c) in FIG. 3, a printing plate according to this embodiment is a strip shape and is featured by extracting an unused printing plate from a roll 8A, which is previously formed by winding the printing plate, as required (each time of replacement of a printing plate) so that the extracted unused printing plate is to be used. A used printing plate is wound by another roll 8B and an exposed portion (a portion that is to be used as a printing plate ready for printing) of the printing plate has a fixed length. Hereinafter, “making the printing plate ready for printing” means writing of a hydrophilic non-image area by irradiating at least part of the surface of the printing plate in a hydrophobic state with activating light (light having energy effectively causing the photocatalyst to show catalytic activity) in accordance with digital data. Whereupon, together with one or more hydrophobic portions on the surface of the printing plate, which portions have not been irradiated with the activating light, a latent image including a hydrophobic image area and a hydrophilic non-image area is formed on the surface of the printing plate.

At step (a), the photosensitive layer 3 the entire surface of which is in a hydrophobic state is irradiated with the activating light so that a non-image area is written. The state in which the entire surface of the photosensitive layer 3 is hydrophobic is called “the initial state in making the printing plate ready for printing.” The “initial state in making the printing plate ready for printing” can be regarded as the start of an actual printing process. Specifically, the “initial state” means a state in which an arbitrary image the digital data of which has been already prepared is about to be written onto the printing plate. Here, a printing plate surface in a hydrophobic state has a contact angle with water thereon equal to or larger than 50°, preferably equal to or larger than 80°, as shown in FIG. 1, which is in such a state that hydrophobic printing ink is held with ease but a fountain solution is hardly deposited.

Subsequently, a non-image area 5 is written into the surface of the photosensitive layer 3 in a hydrophobic state to carry out an image forming step. Writing of a non-image area 5 is performed conforming to digital data of an image so as to coincide with the digital data. This non-image area 5 is in a hydrophilic state which has a contact angle with water smaller than 10° as shown in FIG. 2, in which the fountain solution is held with ease but the printing ink is hardly deposited.

For appearance of a hydrophilic non-image area 5 in accordance with image data, the photosensitive layer 3 is irradiated with the activating light emitted from an imaging head 7 so that the surface of the photosensitive layer 3 is hydrophilized by the action of the photocatalyst. Since a portion that has not been irradiated with the activating light remains in a hydrophobic state, a latent image that is a combination of the hydrophobic image area 6 and the hydrophilic non-image area 5 is formed on the surface of the printing plate as shown at step (b). This completes making the printing plate ready for printing in which state that printing is ready to take place. The imaging head 7 is not limited as long as the system utilizes light having a wavelength equal to or shorter than those of visible light. If the activating light is visible light, an imaging head using violet laser having a wavelength of 405 nm can be used, for example; and if the activating light is ultraviolet light, it is possible to use an imaging head equipped with a light source and a micro-mirror the product name of which is the UV-setter™ 710 manufactured by basysprint GmbH (Germany).

Upon completion of the above steps, a so-called emulsion ink of a mixture of a hydrophobic printing ink and the fountain solution is applied onto the printing plate surface and making a printing plate ready for printing as shown in FIG. 4 is completed. In FIG. 4, the hatching portion represents a state in which the hydrophobic ink is attached to the hydrophobic image area 6. The remaining white portion, i.e., the hydrophilic non-image area 5 represents a state in which the fountain solution preferentially adheres while the hydrophobic ink is repelled and not deposited. The emergence of an image allows the photosensitive layer 3 to function as a printing plate ready for printing. After that, a normal printing process is performed and completed.

The replacement of a used printing plate with an unused printing plate can be easily accomplished in the following manner. Specifically, the photosensitive layer 3 which has completed printing and on which the ink, the fountain solution and paper dust remain is spooled around the roll 8B of a used printing plate and an unused printing plate having a photosensitive layer 3, the entire surface of which is in a hydrophobic state, is extracted from the roll 8A of unused printing plate, thereby restoring the exposed surface of the printing plate, which surface is to be used for printing, to the initial state in making the printing plate ready for printing. The step (c) represents the state in the middle of replacement of a used printing plate with an unused one; and the step (d) represents the state of completion of the replacement so that the entire exposed surface of the printing plate is covered with the photosensitive layer 3 in a hydrophobic state, that is, represents the initial state in making the printing plate ready for printing.

As described above, the printing plate of the present embodiment is a strip shape and flexible, and can therefore be wound into a roll shape so that the used printing plate can be replaced with an unused printing plate, keeping the printing plate being installed in a printing press. This can speed up the cycle of replacement of printing plate. Since a photocatalyst is used for the photosensitive layer 3 and a printing plate is made ready for printing by switching a property of the photocatalyst from hydrophobic to hydrophilic, printing plate dust is not generated contrary to a manner adopting ablation by an IR leaser. Accordingly, defects caused by such dust do not appear and dust pollution of the printing press is avoided whereupon it is possible to do maintenance of the printing press with ease.

Since an image area can be formed without using a hydrophobic substance, such as polymer, no polymer is discarded and washing solvent is not required to wash off polymer as well as producing no polymer waste as compared to a method in which polymer is used to form an image area and removes the polymer after printing finishes in order to reuse the substrate. Namely, imaging without a hydrophobic substance is environmentally friendly.

Further, spooling a used printing plate saves time used in regeneration of the printing plate. Additionally, since each printing plate ready for printing can be made of an unused printing plate, this avoids deterioration of a printing plate, which is inevitable when a printing plate is regenerated and repetitiously reused, whereupon making a printing plate ready for printing can be advantageously accomplished with higher reliability.

Forming of an image is performed using light, so that image formation on a printing plate takes a shorter time and an image with high resolution can be obtained, as compared with a method of making a printing plate ready for printing by an inkjet head.

Since it is further possible to form an image onto the printing plate directly from digital data concerning the image, digitalization of a printing process is realized, thereby greatly reducing corresponding time and costs.

Hereinafter, a description is made in relation to making a printing plate and replacement of a used printing plate to an unused printing plate with reference to the results of experiment and observation by the Inventors.

1. Preparation of Catalyst:

The Ammonia solution was added to a starting material of a titanium sulfate (a product of Wako Pure Chemical Industries, Ltd.) while stirring the mixture to obtain a titanium sulfate hydrolysate, which was filtered through a Buchner funnel. The residue titanium sulfate hydrolysate was washed with deionized water until electrical conductivity of the filtrate came to be 2 μS/cm or lower. After washing, the hydrolysate was dried at room temperature and then burned in the atmosphere for two hours at 400° C. The burned product was roughly milled with a mortar, so that a powder-form photocatalyst was obtained.

2. Making of Printing Plate:

The above powder-form photocatalyst was dispersed in deionized water to obtain slurry (solid content 20 wt %), which was milled in a wet mill (product name: dyno mill PILOT) and was used as a photocatalytic dispersed solution. Alkaline degreasing was performed on a stainless-steel (SUS301) substrate 1 the area of which was 600×200 mm and the thickness of which was 0.05 mm to prepare substrate for a printing plate.

Substrate 1 was dip-coated with the mixture of the photocatalytic dispersed solution and TKC-301, product of Tayca Corporation, at a weight ratio of 1:8, and was then heated at 350° C. to form the photocatalyst layer (photosensitive layer) 3 on the surface of substrate 1, which was to serve as a printing plate. Photosensitive layer 3 had a thickness of approximately 0.1 μm. As a result of measurement using Contact Angle Meter, Model CA-W, manufactured by KYOWA INTERFACE SCIENCE CO., LTD., the surface of printing plate obtained a contact angle of 8° in relation to water thereon, which angle is enough to exhibit adequate hydrophilicity.

After the printing plate was deposited in a dark place for two weeks, the contact angle of the surface of the printing plate and water thereon was measured again with the result that the contact angle was 73° which angle would provide sufficient hydrophobicity.

A 200-mm side of the printing plate the photosensitive layer 3 of which has become hydrophobic was wound around a stainless steel bar having a diameter of 10 mm and a length of 250 mm.

3. Installation of Printing Plate:

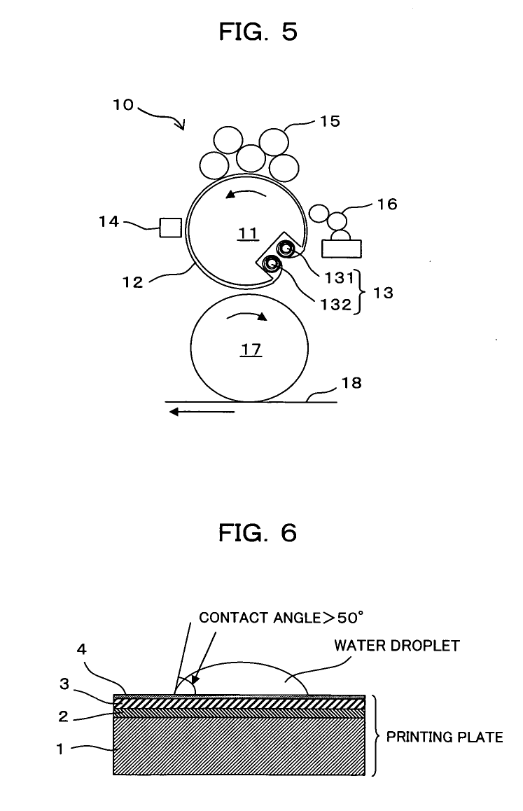

The wound printing plate was installed in an extracting section of a plate cylinder, which includes the extracting section and a spooling section. The other 200-mm side was fixed to a spindle (having a diameter of 10 mm and a length of 250 mm), for spooling the printing plate, of the spooling section so that extraction of the printing plate from the extraction section and the spooling of the printing plate by the spooling section can be concurrently carried out (see FIG. 5). The plate cylinder was made by remodeling a plate cylinder included in a New Ace Pro desk-top offset printing press manufactured by ALPHA ENGINEERING INC.

4. Image Formation:

Halftone dot images of halftone-dot-area percentages ranging from 10% to 100% at 10% intervals were formed on the surface of the printing plate by using an image forming unit that utilizes a semiconductor laser having a wavelength of 405 nm, an output of 5 mW/channel and a beam diameter of 15 μm. A contact angle of water on the surface of the printing plate after undergoing the image forming step an was measured using the above meter with the result that the contact angle of a portion on which the image is written with the semiconductor laser was 8° and that of a portion on which the image was not written was 73°, which angles are enough to be a hydrophilic non-image area 5 and a hydrophilic image area 6, respectively.

5. Printing:

After completion of image formation, the printing plate is mounted on the New Ace Pro desk-top offset printing press manufactured by ALPHA ENGINEERING INC. including the remodeled plate cylinder, and the formed image was printed on sheets of ibest paper using an ink HYECOO B Crimson MZ, product of Toyo Ink Mfg. Co., Ltd., and the fountain solution, a 1% solution of LITHOFELLOW, product of Mitsubishi Heavy Industries, Ltd., at a printing speed of 3,500 sheets/hour. The halftone dot images were successfully printed on the first paper sheet.

6. Replacement of Printing Plate:

After printing is completed, the printing plate (a used portion) on which ink and so forth adhere is wound by the spooling section and, at the same time, an unused printing plate (an unused portion) is extracted by the extracting section so that the exposed part a printing plate, which part is to be used for printing, was replaced by a printing plate the entire surface of which is hydrophobic. Thereby, the printing plate is returned to the initial state in making the printing plate ready for printing.

In order to perform printing and replacement of a printing plate mounted on a printing press, usage of the printing press 10 as shown in FIG. 5 is preferable because, in the printing press 10, the strip-shaped printing plate 12 is wrapped around the plate cylinder 11 including a printing plate replacing unit 13, which comprises printing plate extracting section 131 and spooling section 132. Both ends of the printing plate 12 are wound into roll shapes by the extracting section 131 and the spooling section 132, respectively. Further, an image forming unit 14, inking rollers 15, a fountain solution feeder 16 and a blanket cylinder 17 are installed around the plate cylinder 11.

After completion of printing, the printing press 10 prepares for an ensuing printing as follows. First of all, the used printing plate is spooled by the spooling section 132 and, concurrently, the extracting section 131 extracts an unused printing plate so that the entire printing plate, which is exposed on the curved surface of the plate cylinder 11, is replaced with the unused printing plate.

Secondly, an non-image area is written on the exposed portion of the printing plate 12 by the image forming unit 14 in accordance with prepared digital data representing an image to be printed and then the inking rollers 15, the fountain solution feeder 16 and the blanket cylinder 17 come into contact with the plate cylinder 11. In this arrangement, paper 18 moves in the direction indicated by the arrow in FIG. 5, contacting the blanket cylinder 17, so that fountain solution and ink is sequentially applied to the surface of the printing plate and printing is carried out. A satisfactory light source of the image forming unit 14 emits the activating light and is preferably exemplified by a semiconductor laser having a wavelength of 400-500 nm, or a lamp emitting light in the range of visible to ultraviolet light.

It is possible for the printing press 10 to undergo the series of steps of making a printing plate ready for printing, i.e., replacement of the used printing plate with an unused printing plate through writing of a non-image area, with the printing plate 12 mounted on the printing press 10. This enables the printing press 10 to perform continuous printing processes without halting the operations and also without being interrupted by replacement of a printing plate 12. In FIG. 5, the printing plate replacing unit 13 is incorporated in the plate cylinder 11, but alternatively may be separate from the plate cylinder 11. For example, the printing plate 12 may be temporarily detached from the plate cylinder 11 and a used printing plate may be replaced by an unused printing plate each time of replacement of a printing plate, and subsequently, the unused printing plate may be wrapped around the plate cylinder 11.

(B) Second Embodiment:

FIG. 6 shows a sectional view of a printing plate according to a second embodiment. The printing plate basically comprises a substrate 1, an intermediate layer 2, a photosensitive layer 3 and a hydrophobic coating 4. The substrate 1, the intermediate layer 2 and the photosensitive layer 3 are identical in material to those of the first embodiment, so description is made focusing on the hydrophobic coating 4 here.

The hydrophobic coating 4 is formed by an organic compound having a hydrophobic group and covers the surface of the photosensitive layer 3. A preferable organic compound forming the hydrophobic coating 4 not only reacts or vigorously interacts with at least the hydrophilic portion of the printing plate surface and covers the hydrophilic surface to hydrophobize the surface of the photosensitive layer 3 but is also decomposed with ease by the oxidative decomposition function of the photocatalyst when being irradiated with activating light. A preferable example is an organic titanium compound, an organic silane compound, an isocyanate compound, or an epoxide compound. These organic compounds respectively react with a hydroxy group present at the surface of a photocatalyst to be fixed to the surface, so that an organic compound monomolecular layer is formed on the surface of the photocatalyst in principle. Hydrophobizing the surface of a phtocatalyst by such a monomolecular layer decomposes the organic compound under irradiation with the activating light with ease.

The organic titanium compound is exemplified by (1) an alkoxy titanium, such as a tetra-i-propoxy titanium, a tetra-n-propoxy titanium, a tetra-n-butoxy titanium, a tetra-i-butoxy titanium or a tetrastearoxy titanium, (2) a titanium acylate, such as a tri-n-butoxy titanium stearate or an isopropoxy titanium tristearate, or (3) a titanium chelate, such as a diisopropoxy titanium bisacetylacetonate, a dihydroxy bislactato titanium or a titanium-i-propoxyoctylene glycol, but should by no means be limited to these examples.

The organic silane compound is (1) an alokoxysilane exemplified by a trimethylmethoxysilane, a trimethylethoxysilane, a dimethyldiethoxysilane, a methyltrimethoxysilane, a tetramethoxysilane, a methyltriethoxysilane, a tetraethoxysilane, a methyldimethoxysilane, an octadecyltrimethoxysilane or an octadecyltriethoxy silane, (2) a chlorosilane, such as a trimethylchlorosilane, a dimethyldichlorosilane, a metyltrichlorosilane, a methyldichlorosilane or a dimethylchlorosilane, (3) a silane coupler, such as a vinyl-trichlorosilane, a vinyl-triethoxysilane, a γ-chloropropyltrimethoxysilane, a γ-chloropropyl methyldichlorosilane, a γ-chloropropyl methyldimethoxysilane, a γ-chloropropyl methyldiethoxysilane or γ-aminopropylethoxysilane, or (4) a pholoroalkylsilane exemplified by a perpholoroalkyltrimethoxysilane, but should by no means be limited to these examples.

The isocyanate compound is an isocyanic dodecyl, or an isocyanic octadecyle, but should by no means be limited to the foregoing examples.

The epoxide compound is exemplified by a 1,2-epoxydecane, a 1,2-epoxyhexadecane, or a 1,2-epoxyoctadecane, but should by no means be limited to these examples.

If the organic compound is liquid at room temperature, the compound is coated on the photosensitive layer 3 by a method of either dip coating, roll coating, or blade coating or may be coated with microdrops of the organic compound, which microdrops are formed by a spray. Further, photosensitive layer 3 may be coated with the organic compound in the form of gas obtained by heating the compound to a temperature below the decomposition temperature or in the form of vapor formed by a nebulizer utilizing ultrasound. Needless to say, the compound may be resolved in another solution in order to adjust its concentration and viscosity.

Hereinafter is a description of a manner for making a printing plate ready for printing and for replacing a used printing plate with an unused printing plate according to this embodiment. Also in the second embodiment, the manner of replacement of a used printing plate with an unused printing plate can be described with reference to schematic diagram FIG. 3. The printing plate according to the second embodiment is also a strip shape. An unused printing plate is extracted from a roll 8A, which is previously formed by winding the printing plate, and concurrently a used printing plate is spooled around another roll 8B each time a printing plate is replaced. The surface of the printing plate also of the second embodiment is initially in a hydrophobic state. A printing plate surface in a hydrophobic state has a contact angle with water thereon equal to or larger than 50°, preferably equal to or larger than 80°, as shown in FIG. 6, which is in such a state that hydrophobic printing ink is held with ease but a fountain solution is hardly deposited.

At the first step of image forming, the surface of the printing plate is irradiated with the activating light in accordance with image data so that a surface of the photosensitive layer 3 is hydrophilized by an action of the photocatalyst. The action of the photocatalyst mainly oxidatively decomposes and removes the hydrophobic coating 4 covering the surface of the photosensitive layer 3. Additionally, if the photocatalyst initially exhibits hydrophobicity, the action causes the photocatalyst itself to become hydrophilic. Therefore, an irradiated portion that has been irradiated with the activating light is in a state in which the hydrophilic photosensitive layer 3 is exposed, as shown in FIG. 2, similar to the first embodiment, which is in such a state that a fountain solution is held with ease but the hydrophobic printing ink is hardly deposited. On the other hand, since a printing plate surface that has not been irradiated with the activating light is still covered with the hydrophobic coating 4, a latent image formed by a hydrophobic image area 6 and a hydrophilic non-image area 5 is formed on the surface of the printing plate as shown step (b), thereby making the printing plate ready for printing. The imaging head 7 that irradiates with the activating light can be the same one as the first embodiment.

The subsequent steps of printing and replacement of a used printing plate with an unused printing plate are identical to those performed in the first embodiment, so repetitious description will be omitted here.

As mentioned above, the printing plate of the second embodiment, identical in the following points to that of the first embodiment is a strip shape and flexible enough to be wound into a roll shape so that a used printing plate can be replaced with an unused printing plate keeping the printing plate being mounted on the printing press. This can speed up the printing plate replacement cycle. Additionally, since a photocatalyst forms the photosensitive layer 3 and the printing plate is made ready for printing by decomposing the organic-compound coating 4 covering the photosensitive layer 3, printing plate dust is not generated contrary to a manner adopting ablation using an IR leaser. As a result, similar to the first embodiment, defects caused by such dust do not appear and dust pollution of the printing press is avoided whereupon it is possible to do maintenance of the printing press with ease. Besides the above advantages, the printing plate according to the second embodiment can obtain the same other advantages as the first embodiment.

The printing plate of the second embodiment is also applied to the printing press 10 shown in FIG. 5 in the same manner as the first embodiment. Namely, the printing plate of the second embodiment can serve as the printing plate 12 for the printing press 10.

What is claimed is:

1. A printing plate having a surface on which an image is able to be formed by irradiating the surface with light, wherein a photosensitive layer (3) including a photocatalyst is formed on a strip-shaped windable substrate (1) with or without another layer (2) interposed.

2. A printing plate according to claim 1, wherein:
said photosensitive layer (3) serves as the surface of said printing plate; and
the image is formed in accordance with a conversion in a property of the photocatalyst.

3. A printing plate according to claim 2, wherein the photocatalyst has a property of conversion from hydrophobic to hydrophilic.

4. A printing plate according to claim 1, wherein:
a coating (4), including an organic compound having a hydrophobic group, is formed on said photosensitive layer (3); and
the image is formed in accordance with exposure of a hydrophilic surface of said photosensitive layer (3) which exposure is caused by decomposition of the organic compound by the photocatalyst.

5. A printing plate according to one of claims 1-4, wherein the phtocatalyst responds to light having a wavelength equal to or shorter than those of visible light.

6. A printing plate according to one of claims 1-4, wherein the phtocatalyst responds to light having a wavelength of 600 nm or shorter.

7. A printing press according to one of claims 1-6, wherein the photocatalyst is a titanium oxide photocatalyst or a modified titanium oxide photocatalyst.

8. A printing press comprising:
a printing plate roll (8A) formed by a printing plate (12) defined in one of claims 1-7 which printing plate (12) is wound into a roll shape;
a plate cylinder (11) around which said printing plate (12) extracted from said printing plate roll (8A) is wrapped;
an image forming unit (14) for form an image on the surface of said printing plate (12) wrapped around said plate cylinder (11) by irradiating the surface of said printing plate (12) with activating light; and
a printing plate replacing unit (13) for spooling a used portion of said printing plate (12) and concurrently extracting an unused portion of said printing plate (12) from said printing plate roll (8A).

9. A printing press according to claim 8, wherein said printing plate replacing unit (13) is included in said plate cylinder (11).
